(19) United States
(12) Patent Application Publication
(10) Pub. No.: US 2008/0298404 A1
(43) Pub. Date: Dec. 4, 2008

(54) Radiation Beam Source Device

(75) Inventors: Gert 'T Hooft, Eindhoven (NL); Johannes Joseph Hubertina Barbara Schleipen, Eindhoven (NL); Frank Jeroen Pieter Schuurmans, Eindhoven (NL); Teunis Willem Tukker, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/719,951

(22) PCT Filed: Nov. 23, 2005
(86) PCT No.: PCT/IB05/53879

§ 371 Date: May 23, 2007

(30) Foreign Application Priority Data
Nov. 29, 2004 (EP) 04106156.5

(51) Int. Cl. H01S 3/10; H01S 3/1055

(52) U.S. Cl. 372/28; 372/9

(57) ABSTRACT

For optical data storage applications, for example, for holographic storage applications, a radiation beam (12) with a flat intensity profile is needed. The radiation source device (1) of the invention comprises a beam shaper element (5) and a collimating element (7) between a semiconductor laser (3) and an output coupler (9) and provides such a radiation beam (12) with an increased efficiency. An external resonator is thereby provided. Further, a relatively fast tuning of the wavelength of the output radiation beam (12) can be provided.

### FIELD OF THE INVENTION

The present invention relates to a radiation source device for an optical storage system and an optical data storage device comprising such a radiation source device. More particularly, the present invention relates to a radiation source device and an optical data storage device for two-dimensional optical data storage for applications such as a compact disc, a digital versatile disc and blu-ray disc storage, and for three-dimensional optical storage for applications such as holography storage.

### BACKGROUND OF THE INVENTION

State of the art document U.S. Pat. No. 6,654,183 B2 describes a system for converting optical beams to collimated flat-top beams. This system can transform a substantially non-uniform optical input beam, such as a Gaussian beam, to a substantially uniform output beam.

State of the art document US 2002/0191236 A1 describes a method for improved holographic recording using beam apodization. In this known method a substantially uniform intensity profile of a laser beam from a laser serves to improve the quality of a recorded hologram.

The method known from US 2002/0191236 A1 has the disadvantage of a low efficiency.

### SUMMARY OF THE INVENTION

It is an object of the invention to provide a radiation source device for an optical storage system and an optical data storage device comprising such a radiation source device with an improved efficiency, especially, with an improved performance for reading and or writing of optical data.

This object is solved by a radiation source device as defined in claim 1 and by an optical data storage device as defined in claim 14. Advantageous developments of the invention are mentioned in the dependent claims.

The present invention has the advantage that the beam shaper element, the collimating element and the output coupler build up an optical resonator for the radiation-emitting element. Hence, both the beam shaper and the collimating element are arranged in the light path between the radiation emitting element and the output coupler. Thereby, the loss of energy inside the optical resonator is reduced so that a high efficiency is achieved. Further, the radiation source device outputs a circular shaped radiation beam with a nearly flat intensity profile so that a further shaping and collimating of the radiation beam outside the radiation source device is not necessarily necessary.

The measures as defined in claims 2 and 3 have the advantage that a circular radiation beam is provided for the collimating element. Hence, in combination with the collimating element an efficient light distribution and low noise figures in optical data storage applications are achieved.

The measure as defined in claim 5 has the advantage that, depending on the application, a radiation beam output with a flat intensity profile or with a slightly reverse intensity profile can be formed. A flat intensity profile can be obtained with a flat intensity profile collimator lens. This is preferred for two-dimensional recording systems, wherein the rim intensity of the radiation beam is larger than 60% of the center intensity.

The measure as defined in claim 9 has the advantage that the wavelength of the radiation beam output can easily be changed. A control of this wavelength can be provided by the measure as defined in claim 10.

The measure as defined in claim 11 has the advantage that an adjustment and control of the wavelength of the radiation beam output from the radiation source device is provided without any mechanically moving parts. Thereby, the mirror element can comprise a liquid crystal mirror.

The measure as defined in claim 12 has the further advantage that the radiation beams of different wavelengths incidenting on the mirror element are at least nearly parallel to each other. Thereby, the mirror element can be arranged so that the radiation beams of different wavelengths are incidenting perpendicular on the surface of the mirror element. Therewith, the reflection of the radiation beams on the mirror element is improved so that the efficiency of the radiation source device is improved over the whole range of provided frequencies.

The measure as defined in claim 13 has the advantage that the reflection of the radiation beams of different wavelengths on the mirror element is further improved.

These and other aspects of the invention will be apparent from and elucidated with reference to the embodiments described hereinafter.

### BRIEF DESCRIPTION OF THE DRAWINGS

The present invention will become readily understood from the following description of preferred embodiments thereof made with reference to the accompanying drawings, in which like parts are designated by like reference signs and in which:

FIG. 1 shows a radiation source device according to a first embodiment of the present invention;

FIG. 2 shows a graph illustrating different intensity profiles of a radiation beam;

FIG. 3 shows a radiation source device according to a second embodiment of the present invention;

FIG. 4 shows a radiation source device according to a third embodiment of the present invention;

FIG. 5 shows a radiation source device according to a fourth embodiment of the present invention; and

FIG. 6 shows an optical data storage device comprising a radiation source device, as shown in anyone of FIGS. 1, 3, 4 and 5.

### DESCRIPTION OF THE PREFERRED EMBODIMENTS

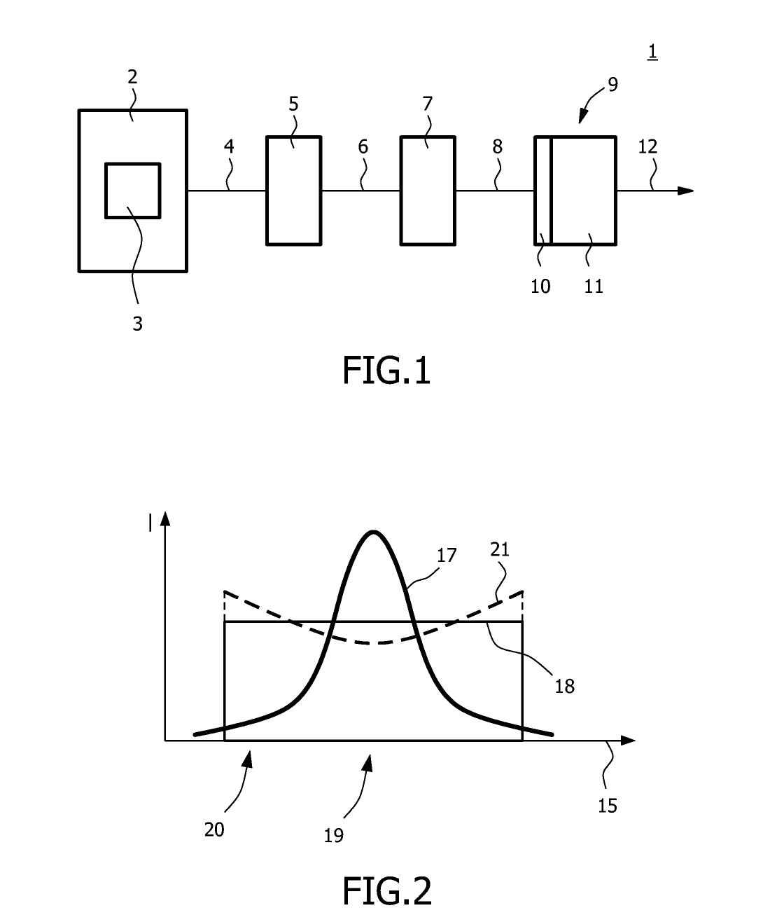

FIG. 1 shows a radiation source device 1 according to a first embodiment of the invention. The radiation source device 1 can be used in an optical storage system, especially for two-dimensional optical data storage and three-dimensional holographic storage. The optical storage system can use a compact disc, a digital versatile disc, a blu-ray disc, a storage medium for holographic storage or an other optical storage medium. But, the radiation source device 1 of the invention is not limited to this mentioned data storage systems and can also be used in other applications.

The radiation source device 1, as shown in FIG. 1, comprises a radiation-emitting element 2. The radiation-emitting element 2 comprises a semiconductor laser 3 and can comprise further elements such as lenses. The radiation-emitting element 2 is emitting an elliptical radiation beam 4. The elliptical radiation beam 4 can, for example, comprise an elliptical beam profile with an aspect ratio of 1 to 3 or 2 to 3. Thereby, the divergence of the radiation beam 4 in the plane parallel to the active region of the semiconductor laser 3, i.e. parallel to the polarization axis, is a factor 2 to 3 lower than for the perpendicular direction.

The radiation beam 4 is input to a beam shaper element 5 for shaping the radiation beam 4 emitted from the radiation-emitting element 2 in a radiation beam with a circular beam profile. Hence, the radiation beam 6 output from the beam shaper element 5 has an aspect ratio of at least nearly 1.

The circular radiation beam 6 is input to a collimating element 7. The collimating element 7 is arranged to collimate the radiation beam 6 and to create an at least nearly flat intensity profile. Thereby, the collimating element 7 can be or comprise a flat intensity profile lens or a reversed intensity profile lens. A reversed intensity profile lens is preferred for holographic systems using a spatial light modulator. The different beam profiles are described below with reference to FIG. 2.

In FIG. 1, the collimating element 7 outputs a radiation beam 8 having a circular beam profile and an at least nearly flat intensity profile. The radiation beam 8 is incidented on an output coupler 9. The output coupler 9 comprises a bragg reflector 10 mounted on a transparent substrate 11. The bragg reflector 10 reflects a part of the incident radiation beam 8 back to the radiation emitting element 2. Thereby, the reflected radiation beam 8 passes successively through the collimating element 7 and the beam shaper element 5. Hence, between the beam shaper element 5 and the collimating element 7 an aspect ratio and intensity profile corresponding to the radiation beam 6 is again obtained for the reflected beam. Also, between the radiation-emitting element 2 and the beam shaper element 5 an aspect ratio of the beam profile and an intensity profile corresponding to the radiation beam 4 is again obtained by the reflected beam. Therefore, the loss of radiation is reduced and a high efficiency for the radiation source device 1 is achieved.

The part of the radiation beam 8 not reflected back to the radiation emitting element 2 passes through the bragg reflector 10 and the transparent substrate 11 and is output as an output radiation beam 12 of the radiation source device 1.

The radiation-emitting element may be or comprise a gain medium, or may be or comprise a semiconductor laser or a semiconductor laser chip such as for example used in lasers applied in compact disc or digital versatile disc systems. Specifically, the radiation-emitting element 2 can comprise a semiconductor laser 3 with an output power of 70 mW and a wavelength of 405 nm in free running mode.

FIG. 2 shows a diagram for illustrating the intensity profile of the output radiation beam 12 of the radiation source device 1. On the axis 15 of abscissas a direction perpendicular to the propagation of the radiation beam 12 is shown. On the axis 16 of ordinates the intensity of the radiation beam 12 is shown. The solid line 17 shows the intensity profile of a Gaussian intensity profile. The radiation beam 4 can have this Gaussian intensity profile. The solid line 18 shows a flat intensity profile. In this case, the intensity of the radiation beam in the center 19 is equal to the intensity in the region of the rim 20. The discontinuous line 21 shows a reversed intensity profile. Thereby, a rim intensity in the rim 20 is slightly greater than the center intensity in the center 19 of the radiation beam. Therefore, the line 21 shows a nearly flat intensity profile. The output radiation beam 12 can comprise the intensity profile shown by the solid line 18 or the discontinuous line 21. The intensity profile of the radiation beam 8 corresponds to the intensity profile of the radiation beam 12.

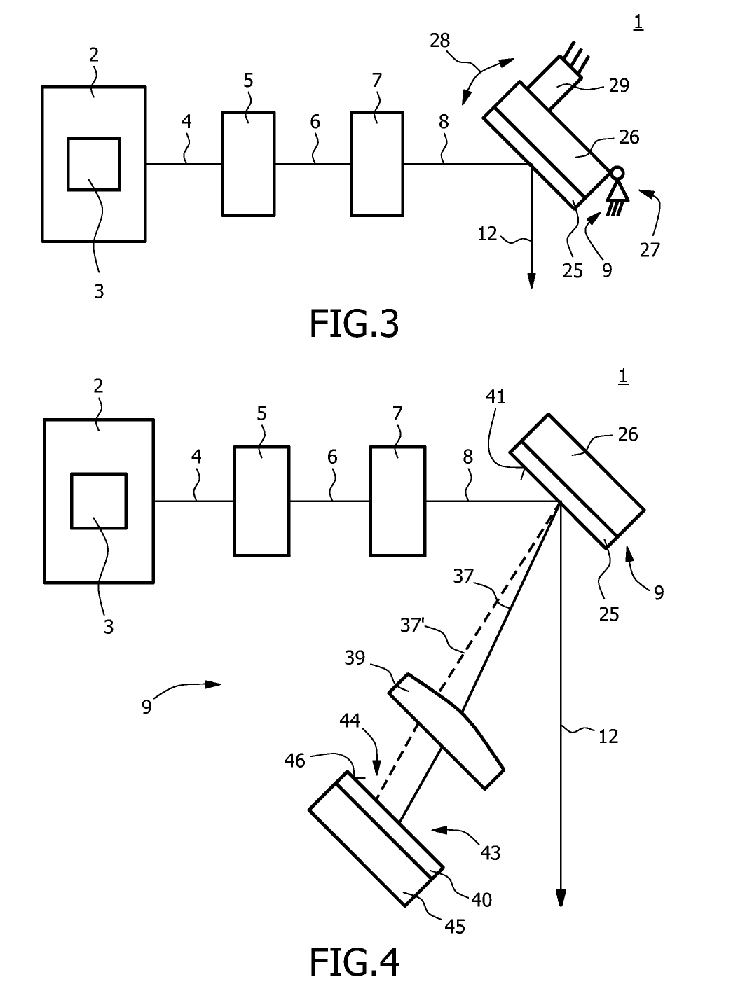

FIG. 3 shows a second embodiment of the radiation source device 1 of the present invention. In this second embodiment, the radiation beam 8 output from the collimating element 7 is incidented on a refractive grating 25 of the output coupler 9. The refractive grating 25 serves as a tuning grating and is mounted on a substrate 26. The substrate 26 is not necessarily transparent. The angle of incidence of the radiation beam 8 with respect to the refractive grating 25 is at least nearly 45°. Therewith, the aspect ratio of the beam profile of the output radiation beam 12 equals at least nearly that of the radiation beam 8. Hence, the output radiation beam 12 also has a circular beam profile.

The refractive grating 25 mounted on the substrate 26 is mechanically movable. A bearing 27 which is fixed relative to the radiation emitting element 2, the beam shaper element 5 and the collimating element 7 defines a swiveling axis for turning the refractive grating 25 together with the substrate 26. This turning can be performed in a clockwise or a counterclockwise direction 28. For a wavelength of, for example, 400 nm, due to the angle of incidence near 45°, the ruling of the refractive grating is preferred to be around 3000 lines per mm. For a span of 10 nm the total variation in the angle of incidence is 25 mrad. Such a variation is applied by means of a piezo-element 29. The piezo-element 29 is attached to the substrate 26 opposite to the bearing 27 and fixed on one side relative to the radiation emitting element 2. Hence, the wavelength of the output radiation beam 12 is controlled by applying a voltage to the piezo element 29.

It is advantageous that the first order of the reflected radiation beam 8 is directed back towards the semiconductor laser 3 of the radiation-emitting element 2. The zero order reflection of the radiation beam 8 then serves as the output radiation beam 12. In the second embodiment the output coupler comprises the refractive grating 25, the substrate 26, the bearing 27 and the piezo-element 29.

FIG. 4 shows a third embodiment of the present invention. The radiation source device 1 of the third embodiment comprises a reflecting element 25 and a mirror element 40. Thereby, the reflecting element 25 is a refractive grating 25. The refractive grating 25 mounted on the substrate 26 and the mirror element 40 are fixed with respect to the radiation emitting element 2.

The radiation beam 4 from the radiation-emitting element 2 propagates through the beam shaper element 5 and the collimating element 7 and is subsequently dispersed on the refractive grating 25. The zeroth order reflection from the refractive grating 25 is used for outcoupling the output radiation beam 12. Further, the radiation beam 37 reflected in first order from the refractive grating 25 is focused with a focusing lens 39 on the mirror element 40. The mirror element 40 comprises a changeable reflecting area 43 adapted as a high reflecting part of the mirror element 40. From the reflecting area 43 the radiation beam 37 is fed back into the radiation-emitting element 2 via all the optical elements 39, 25, 7 and 5. The reflecting area 43 of the mirror element 40 is in the focal plane of the focusing lens 39.

Different wavelengths will have a different direction when leaving the refractive grating 25 and will therefore be focused with the focusing lens 39 on a different position on a surface 46 of the mirror element 40. By turning different pixels on and off, a different reflecting area 44 of the mirror element 40 can be selected to choose a proper wavelength. Hence, the wavelength of the output radiation beam 12 can be tuned without mechanically moving parts. The third embodiment will also become further apparent from the following description of the fourth embodiment of the invention.

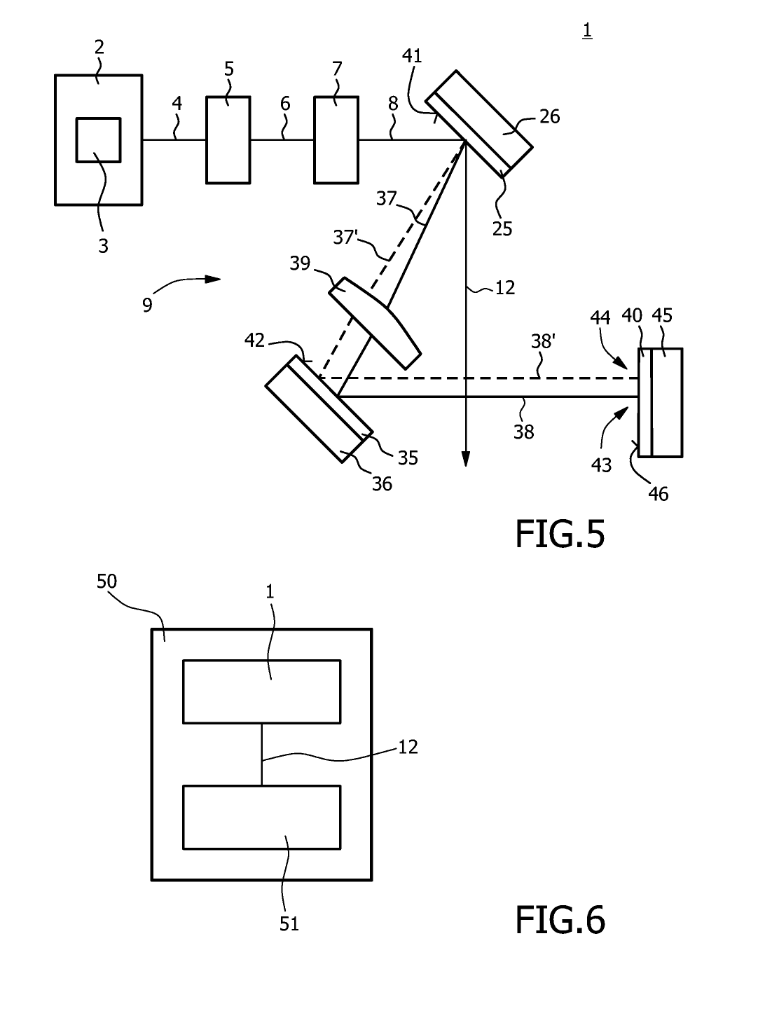

FIG. 5 shows a fourth embodiment of the present invention. The radiation source device 1 of the fourth embodiment comprises the reflecting element 25 which is a refractive grating 25. Also, the radiation source device 1 comprises a further reflecting element 35 which is a refractive grating 35. The refractive grating 35 is mounted on a substrate 36 which is not necessarily transparent. The refractive grating 25 mounted on the substrate 26 and the refractive grating 35 mounted on the substrate 36 are fixed with respect to the radiation-emitting element 2.

The radiation beam 8 is incidented in zero order to the refractive grating 25, and a radiation beam 37 is reflected in first order from the refractive grating 25 to the further refractive grating 35. The radiation beam 37 is incidented in first order to the refractive grating 35, and a radiation beam 38 is reflected from the refractive grating 35 in zero order. The radiation beam 37 passes through a focusing lens 39 for focusing the radiation beam 38 on the mirror element 40. Thereby, it is advantageous that the mirror element 40 is arranged in the focal point of the focusing lens 39. The mirror element 40 is arranged to reflect the incident radiation beam 38 at a changeable reflecting area 43. The reflecting area 43 can be changed to another reflecting area of the mirror element 40, for example, to the reflecting area 44. The refractive grating 35 placed between the focusing lens 39 and the mirror element 40 diffracts the radiation beam 38 reflected from the mirror element 40 back to its original direction.

Therefore, at least a part of the radiation beam 38 is reflected back via the refractive grating 35 and the refractive grating 25 to the radiation emitting element 2 so that an external resonator is built up for a specific wavelength.

A surface 41 of the refractive grating 25 is arranged parallel to a surface 42 of the refractive grating 35. If the reflecting area 43 is changed to the reflecting area 44, then a different light path is selected, as shown by the discontinuous line. In this case, due to the wavelength dependent direction of the first order reflection from the refractive grating 25, the radiation beam 37′ of first order reflection is selected. The radiation beam 37′ is incidented on the refractive grating 35. A radiation beam 38′ is therefore reflected in zero order from the refractive grating 35. The radiation beam 37′ passes through the focusing lens 39 so that the radiation beam 38′ is focused on the mirror element 40 at the reflecting area 44. Due to the parallel arrangement of the surfaces 41 and 42, the directions of propagation of the radiation beams 38, 38′ are parallel to each other. Therefore, the mirror element 40 can be arranged so that the angle of incidence of both the radiation beam 38 and the radiation beam 38′ on the surface 46 of the mirror element 40 is 90°. Hence, the efficiency of the reflection on the mirror element 40 is high and at least nearly independent from the selected wavelength.

The mirror element 40 is connected to a control unit 45, wherein the control unit 45 controls the position of the reflecting area 43, 44 on the screen of the mirror element 40. Therewith, the control unit 45 controls the wavelength of the output radiation beam 12 which is reflected from the refractive grating 25 in zero order.

In the fourth embodiment of the invention the output coupler 9 comprises the refractive grating 25 mounted on the substrate 26, the refractive grating 35 mounted on the substrate 36, the focusing lens 39 and the mirror element 40 connected to the control unit 45. The output coupler 9 of the radiation source device 1 according to the fourth embodiment of the invention has the advantage that the wavelength of the radiation beam 12 can be tuned relatively fast, without the use of moving parts in the resonator. Further, less losses at the outer ends of the tuning rang of the radiation source device 1 are achieved.

FIG. 6 shows an optical data storage device 50 for optical data storage comprising a radiation source device 1 according to anyone of the first, second, third or fourth embodiments. The optical data storage device 50 also comprises a read/write-unit 51 for reading and writing operations for optical data storage. The output radiation beam 12 output from the radiation source device 1 is applied to the read/write-unit 51. In particular, volumetric holographic data storage needs a radiation source with a long coherence length, and for wavelength multiplexing also a tunable source. The radiation source device 1 solves the problem concerning light path efficiency. For two-dimensional optical data storage the radiation source device 1 can also be arranged to provide a single longitudinal mode. This has the advantage of a small optical feedback sensitivity, and consequently an increased signal to noise ratio. For holography storage a flat intensity profile is needed in order to address all the pixels equally of an spatial light modulator in a writing setup. In reading there is a corresponding demand for the CCD Camera. But, intensity variations of up to ten percent can, depending on the application, usually be tolerated.

Although an exemplary embodiment of the invention has been disclosed, it will be apparent to those skilled in the art that various changes and modifications can be made which will achieve some of the advantages of the invention without departing from the spirit and scope of the invention, such modifications to the inventive concept are intended to be covered by the appended claims in which the reference signs shall not be construed as limiting the scope of the invention. Further, in the description and the appended claims the meaning of “comprising” is not to be understood as excluding other elements or steps. Further, “a” or “an” does not exclude a plurality, and a single processor or other unit may fulfill the functions of several means recited in the claims. Also, the wavelength of the radiation beams is not limited to the visible spectrum.

1. Radiation source device (1) for an optical storage system, which radiation source device comprises:
at least a radiation emitting element (2) for emitting a radiation beam,
at least a beam shaper element (5) for shaping the radiation beam emitted from said radiation emitting element to an at least nearly circular radiation beam,
at least a collimating element (7), wherein said circular radiation beam from said beam shaper element is input to said collimating element and said collimating element is arranged to output a radiation beam with an at least nearly flat intensity profile, and
at least an output coupler (9) which is arranged to partially reflect said radiation beam from said collimating element at least indirectly back to said radiation emitting element and to output a output radiation beam (12).

2. Radiation source device according to claim 1, characterized in that said radiation emitting element (2) comprises a semiconductor laser (3) emitting an elliptical radiation beam.

3. Radiation source device according to claim 2, characterized in that said beam shaper element (5) shapes said elliptical radiation beam output from said radiation emitting element to said circular radiation beam.

4. Radiation source device according to claim 1, characterized in that said collimating element (7) comprises at least a collimating lens.

5. Radiation source device according to claim 1, characterized in that said collimating element (7) is arranged to output a radiation beam having a rim intensity that is at least slightly greater than or equal to the center intensity of said radiation beam.

6. Radiation source device according to claim 1, characterized in that said output coupler (9) comprises at least a reflecting element (10, 25, 35).

7. Radiation source device according to claim 6, characterized in that said reflecting element is a bragg reflector (10).

8. Radiation source device according to claim 6, characterized in that said reflecting element is a refractive grating.

9. Radiation source device according to claim 8, characterized in that said reflecting element is arranged to be movable to change an angle of incidence of said radiation beam on said reflecting element.

10. Radiation source device according to claim 9, characterized in that said reflecting element is movable by a piezo-element (29) to control the wavelength of said output radiation beam.

11. Radiation source device according to claim 1, characterized in that said output coupler comprises a mirror element (40), wherein said mirror element is arranged to reflect an incident radiation beam at a changeable reflecting area, and said radiation source device comprises a control unit (45) to control the position of said reflecting area on the mirror element (40) to set the wavelength of said radiation beam output.

12. Radiation source device according to claim 11, characterized by a further reflecting element, wherein said further reflecting element is arranged so that a surface of said further reflecting element (35) is at least at most parallel to a surface of said reflecting element.

13. Radiation source device according to claim 11, characterized by at least a focusing lens (39) for focusing the radiation beam on the mirror element.

14. Optical data storage device (50) for optical data storage comprising a radiation source device according to claim 1.
